(19) United States
(12) Patent Application Publication
(10) Pub. No.: US 2016/0138619 A1
(43) Pub. Date: May 19, 2016

(54) Conserve Energy Through Independent Pump Control in a Hydraulic System

(71) Applicant: Caterpillar Inc., Peoria, IL (US)

(72) Inventors: Jiao Zhang, Naperville, IL (US); Tonglin Shang, Bolingbrook, IL (US); Santosh Ancha, Peoria, IL (US); Pengfei Ma, Naperville, IL (US)

(73) Assignee: Caterpillar Inc., Peoria, IL (US)

(21) Appl. No.: 14/541,586

(22) Filed: Nov. 14, 2014

(51) Int. Cl. F15B 11/028; F15B 13/042; F15B 11/10

(52) U.S. Cl. CPC F15B 11/028; F15B 11/10; F15B 13/042; F15B 2211/20576; F15B 2211/25

(57) ABSTRACT

A hydraulic system includes a first pump to provided pressurized fluid to a first hydraulic circuit and a second pump to provide pressurized fluid to a second hydraulic circuit. When the hydraulic system is in an energy conservation mode, the output power of the first pump is reduced to less than the hydraulic power demand of the first hydraulic circuit.

TECHNICAL FIELD

This patent disclosure relates to energy conservation, and more particularly to a system and method for conserving energy in a hydraulically powered linkage system.

### BACKGROUND

In a machine, such as an excavator, a backhoe or a shovel, a hydraulic circuit may include multiple variable displacement pumps in fluid communication with at least one hydraulic actuator to handle a variable load. The pumps provide pressurized hydraulic fluid to each of the actuators, such as a hydraulic cylinder or a hydraulic motor, to move the load. The actuators may be connected to work implements, such as a boom, stick, bucket and/or a swing gear train.

A typical digging operation for an excavator or other machine with an implement may have a plurality of phases. Such phases may include, but are not limited to, an initial phase, a digging phase, a digging-boom-up-overrunning-load phase, a digging-boom-up-light-resistive-load phase and a boom-lift phase. In the initial phase, there is no digging load and the boom, stick and bucket are moved into position to begin digging. In the digging phase, the boom is generally held in place while an implement, for example a stick and bucket, attached to the boom is commanded to dig. In the digging-boom-up-overrunning-load phase, the boom is moved upward while the implement is digging. In such a phase, the reaction digging force applied on the boom cylinder through the implement is greater than the resistive force of gravity. In the digging-boom-up-light-resistive-load phase, the boom is moved upward while the implement is digging but the reaction digging force is slightly less than the resistive force of gravity. In the boom-lift phase, the implement is no longer digging and the boom is moved upward along with the load contained in the implement.

When the hydraulic circuit transitions between the digging phase to the digging-boom-up-overrunning-load phase, the boom portion of the hydraulic circuit generally transitions from a holding operation to a lifting operation, the bucket and stick circuits carry a high digging load, and the pump may supply fluid at high pressure to support the digging function. For a short period of time, for example, about 0.5 to about 2 seconds, the boom cylinder may be in an overrunning load condition. When lifting the boom with an overrunning load condition, the head end of the actuator for the boom receives pump flow under a pressure, which may cause pressure modulation by a compensation valve disposed downstream of the pumps and upstream of the head end of the actuator. A relatively large amount of power may be dissipated due to the fluid pressure drop across the compensation valve. Similar power dissipation may occur when the hydraulic circuit transitions to the digging-boom-up-light-resistive-load phase.

Such power dissipation may be reduced by providing fluid from the rod end of the boom actuator to the head end of the actuator. Such fluid regeneration reduces pump flow because less fluid may be provided by the pumps to perform the lifting operation. However, because the pump output power remains constant, pump flow to the work implement actuator is not reduced during fluid regeneration and remains relatively high. This may make it difficult to control the bucket. Thus, what is needed is a system and method to optimize energy savings from fluid regeneration while providing for greater control of the work implement.

U.S. Pat. No. 4,537,029 (the '029 patent) discloses vehicles including a hydraulic system having first and second pumps. The first and second pumps may be selectively operated depending on flow demand. The selective operation of pumps, however, is not performed in response to an energy conservation mode, such as the one in which pump flow is reduced by transferring fluid from the rod end to the head end of a hydraulic actuator.

The present disclosure is directed to overcoming one or more of the shortcomings set forth above.

### SUMMARY

In one aspect, the disclosure is directed at a hydraulic system. A first pump is configured to provide a pressurized fluid to a first hydraulic circuit. A second pump is configured to provide the pressurized to a second hydraulic circuit. A controller is configured to determine whether or not the hydraulic system is operating in an energy conservation mode. In response to a determination that the hydraulic system is not operating in the energy conservation mode, the controller operates the first pump and the second pump proportional to the hydraulic power demand of at least the first hydraulic circuit. In response to a determination that the hydraulic system is operating in the energy conservation mode, the controller operates the first pump at an output power less than the hydraulic power demand of the first hydraulic circuit.

In one aspect, the disclosure is directed at a method of operating a hydraulic system. The hydraulic system includes a first pump that provides a pressurized fluid to a first hydraulic circuit. A second pump provides the pressurized fluid to a second hydraulic circuit. It is determined that the first hydraulic circuit is operating in an energy conservation mode. Power savings that may be caused by operating the first hydraulic circuit in the energy conservation mode is calculated. The first output power is decreased in proportion to the energy savings.

In one aspect, a machine for conserving energy in its hydraulic system is provided. The hydraulic system includes a boom, a bucket connected to the boom, a hydraulic circuit that is employed to actuate the boom and the bucket, and a pump for providing a pressurized fluid to the hydraulic circuit at an output power. A controller is provided and configured to receive a boom control command to move the boom upward and a bucket control command to dig. An amount of the pressurized fluid that is provided by the pump to the hydraulic circuit is reduced. Power savings that may be caused by reducing the amount of the pressurized fluid that is provided to the hydraulic circuit is calculated. Output power of the pump is reduced in proportion to the energy savings.

### BRIEF DESCRIPTION OF THE DRAWINGS

FIG. 1 is a view of an embodiment of an exemplary vehicle wherein a hydraulic system in accordance with the teachings of this disclosure may be used;

FIG. 2 is a schematic illustration of an exemplary disclosed hydraulic system that may be used with the machine of FIG. 1;

FIG. 3 is a partial detailed schematic illustration of the exemplary disclosed hydraulic system of FIG. 2; and

FIG. 4 is a flow chart illustrating an exemplary method for conserving energy in the hydraulic system of FIG. 2.

### DETAILED DESCRIPTION

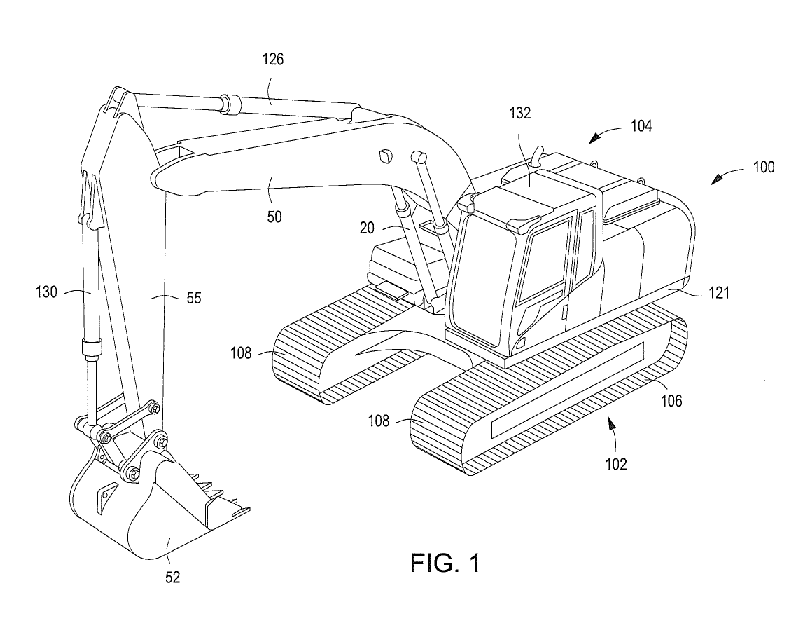

FIG. 1 illustrates an example of a vehicle or a machine 100 that incorporates the features of the present disclosure. The exemplary machine 100 in FIG. 1 is a machine 100. The machine 100 includes an undercarriage 102 and an upper structure 104. The undercarriage 102 includes a generally H-shaped frame 106 that supports two crawler tracks 108 along its edges and includes a post (not shown) supporting a ring gear (not shown) close to its center. The crawler tracks 108 are moved by sprockets that are rotated by hydraulic drive motors (not shown) or electric drive motors connected to the H-shaped frame 106. The ring gear includes a plurality of teeth arranged long its inner periphery, which mesh with a drive sprocket powered by a swing motor (not shown). The swing motor may be connected to the upper structure 104 such that rotation of the drive sprocket causes the relative rotation of the upper structure 104 relative to the undercarriage 102. The upper structure 104 includes a boom 50 that is pivotally connected to an upper structure frame 121 and is pivoted by use of two boom actuators 20. An arm, which is referred to herein as a stick 55, is pivotally connected at an end of the boom 50 and pivoted by an arm actuator 126. A bucket 52 is connected at the end of the stick 55 and is pivoted by a bucket actuator 130. The boom actuators 20, the arm actuator 126 and the bucket actuator 130 are embodied in the illustrations as linear hydraulic cylinders, which are configured to be extended and retracted by selective portion of pressurized fluid on one side of a hydraulic piston disposed inside of the hydraulic cylinder. The various functions of the machine 100 may be controlled in part the appropriate handling of various control devices by an operator occupying a cab 132. The swing motor may be powered by hydraulic or electric power.

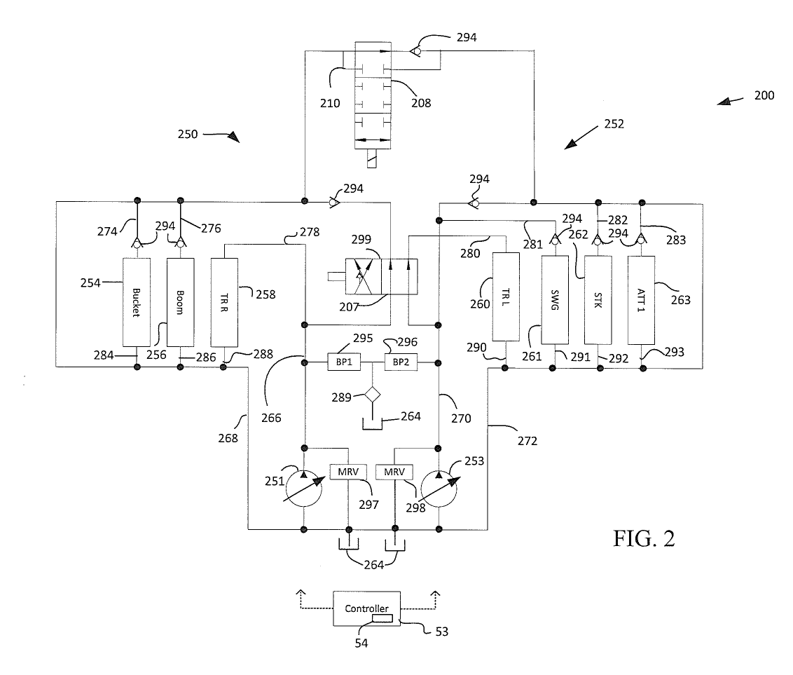

Referring to FIG. 2, the machine 100 may include a hydraulic system 200 having a plurality of fluid components that cooperate to move the machine 100. In particular, hydraulic system 200 may include a first hydraulic circuit 250 configured to receive a first pressurized fluid from a first source, such as a first pump 251, and a second hydraulic circuit 252 configured to receive a second pressurized fluid from a second source, such as a second pump 253. First hydraulic circuit 250 may include a bucket control circuit 254, a boom control circuit 256, and a right travel control circuit 258 connected to receive the first pressurized fluid in parallel. Second hydraulic circuit 252 may include a left travel control circuit 260, a swing control circuit 261, a stick control circuit 262, and one or more instances of attachment control circuit 263 connected in parallel to receive the second pressurized fluid.

It should be noted that for illustrative purposes, the hydraulic system 200 is depicted in FIG. 2 as a plurality of functional blocks. Certain elements that do not need to be shown in detail to inform the accompanying description of the hydraulic system 200 are, for ease of illustration, grouped together into such functional blocks. For instance, it should be understood that the bucket control circuit 254, the boom control circuit 256, the right travel control circuit 258, the left travel control circuit 260, the swing control circuit 261, the stick control circuit 262, and the attachment control circuit 263 may include components, such as valves, hydraulic cylinders, supply lines, drain lines, pressure sensors, etc.

The first pump 251 and the second pump 253 may draw fluid from the tank 264 and pressurize the fluid to predetermined levels. Specifically, each of the first pump 251 and the second pump 253 may embody a pumping mechanism such as, for example, a variable displacement pump, a fixed displacement pump, or another source known in the art. The first pump 251 and the second pump 253 may each be separately connected to a power source (not shown) of the machine 100 by, for example, a countershaft (not shown), a belt (not shown), an electrical circuit (not shown), or in any other suitable manner. Alternatively, each of the first pump 251 and the second pump 253 may be indirectly connected to the power source via a torque converter, a reduction gear box, or in another suitable manner. The first pump 251 may produce the first pressurized fluid independent of the second pressurized fluid produced by the second pump 253. The first and second pressurized fluids may be at different pressure levels and/or flow rates.

In one embodiment, the first pump 251 may have a first output power, and the second pump 253 may have a second output power. In one example, during certain operations, such as moving the boom 50 or moving the stick 55, the hydraulic system 200 may not operate at maximum power. In such an instance, the setting of the first output power and the second output power may be set commensurate to the demand for the particular operation.

In another example, during certain operations, such as lifting or digging, the hydraulic system 200 may operate at maximum power. In such an instance, the first output power and the second output power may be set to one half of the maximum power, respectively. Accordingly, the hydraulic system 200 can be operated such that the value of the output power of the first pump 251 and the value of the output power of the second pump 253 are equal. In another example, during operation of the hydraulic system 200 at maximum power, as will be further discussed herein, the value of the output power of the first pump 251 and the value of the output power of the second pump 253 may be different. For instance, the value of the output power of the first pump 251 may be reduced relative to the output power of the second pump 253, and vice versa. In one, the value of the output power of the first pump 251 may be reduced relative to the output power of the second pump 253 when the hydraulic system 200 is operating in an energy conservation mode.

The fluid may include, for example, dedicated hydraulic oil, engine lubrication oil, transmission lubrication oil, or any other fluid known in the art. One or more hydraulic systems within the machine 100 may draw fluid from and return fluid to the tank 264. It is contemplated that the hydraulic system 200 may include a single instance of the tank 264 or multiple instances of the tank 264.

Referring to FIG. 1 and FIG. 2, each of the bucket control circuit 254, the boom control circuit 256, the right travel control circuit 258, the left travel control circuit 260, the swing control circuit 261, the stick control circuit 262, and the attachment control circuit 263 may regulate the motion of their respective fluid actuators. Specifically, the bucket control circuit 254 may have elements movable to control the motion of the bucket actuator 130 associated with the bucket 52; the boom control circuit 256 may have elements movable to control the motion of the boom actuators 20 associated with the boom 50; and the stick control circuit 262 may have elements movable to control the motion of the arm actuator 126 associated with the stick 55. Likewise, the right travel control circuit 258 and the left travel control circuit 260 may have valve elements movable to control the motion of the left and right travel motors (not shown) associated with the crawler tracks 108 of the machine 100. The swing control circuit 261 may have elements movable to control the swinging motion of the swing motor (not shown), and the attachment control circuit 263 may have elements movable to control the motion of an attachment (not shown).

Referring to FIG. 2, the first hydraulic circuit 250 and the second hydraulic circuit 252 may be connected to allow pressurized fluid to flow into and drain from their respective actuators via common passageways. Specifically, the control circuits 254, 256, 258 of the first hydraulic circuit 250 may be connected to the first pump 251 by way of a first common supply passageway 266, and to the tank 264 by way of a first common drain passageway 268. The control circuits 260, 261, 262, 263 of the second hydraulic circuit 252 may be connected to the second pump 253 by way of a second common supply passageway 270, and to the tank 264 by way of a second common drain passageway 272. The bucket control circuit 254, the boom control circuit 256, and the right travel control circuit 258 may be connected in parallel to the first common supply passageway 266 by way of individual fluid passageways 274, 276, and 278, respectively, and in parallel to the first common drain passageway 268 by way of individual fluid passageways 284, 286, and 288, respectively. Similarly, the left travel control circuit 260, the swing control circuit 261, the stick control circuit 262, and the attachment control circuit 263 may be connected in parallel to the second common supply passageway 270 by way of individual fluid passageways 280, 281, 282, and 283 respectively, and in parallel to the second common drain passageway 272 by way of individual fluid passageways 290, 291, 292, and 293, respectively. A check valve 294 may be disposed within each of the individual fluid passageways 274, 276, 281, 282, and 283 to provide for unidirectional supply of pressurized fluid to control circuits 254, 256, 261, 262, and 263, respectively.

Because the elements of the bucket control circuit 254, the boom control circuit 256, the right travel control circuit 258, the left travel control circuit 260, the swing control circuit 261, the stick control circuit 262, and the attachment control circuit 263 may be similar and function in a related manner, only the operation of the boom control circuit 256 will be discussed further herein.

Referring to FIG. 1, the supply and drain elements of each control valve may be solenoid movable against a spring bias in response to a command. In particular, the actuators 20, 126, 130, the left and right travel motors, the attachments, and the swing motor may move at velocities that correspond to the flow rates of fluid into and out of corresponding pressure chambers and with forces that correspond with pressure differentials between the chambers. To achieve the operator-desired velocity indicated via the interface device position signal, a command based on an assumed or measured pressure may be sent to the solenoids (not shown) of the supply and drain elements that causes them to open an amount corresponding to the necessary flow rate. The command may be in the form of a flow rate command or a valve element position command.

The common supply passageways 266, 270 and the drain passageways 268, 272 of the first hydraulic circuit 250 and the second hydraulic circuit 252 may be interconnected for make-up and relief functions. In particular, the first common supply passageway 266 and the second common supply passageway 270 may receive make-up fluid from the tank 264 by way of a common filter 289, a first bypass element 295 and a second bypass element 296, respectively. As the pressure of the first or second pressurized fluids drops below a predetermined level, fluid from the tank 264 may be allowed to flow into the first hydraulic circuit 250 and the second hydraulic circuit 252 by way of the common filter 289, the first bypass element 295, and/or the second bypass element 296, respectively. In particular, as fluid within the first hydraulic circuit 250 or the second hydraulic circuit 252 exceeds a predetermined pressure level, fluid from the corresponding circuit having the excessive pressure may drain to the tank 264 by way of a main relief valve 297 and/or a main relief valve 298, respectively. The main relief valve 297 and the main relief valve 298 may be hydro-mechanical valves movable to any position between a fully open flow-passing position and a fully closed flow-blocking position.

A straight travel valve 299 may selectively rearrange the right travel control circuit 258 and the left travel control circuit 260 into a parallel relationship with each other. In particular, the straight travel valve 299 may include a valve element 207 movable from a neutral position toward a straight travel position. When valve element 207 is in the neutral position, the right travel control circuit 258 and the left travel control circuit 260 may be independently supplied with pressurized fluid from the first pump 251 and the second pump 253, respectively, to control the right and left travel motors separately. When the valve element 207 is in the straight travel position, however, the right travel control circuit 258 and the left travel control circuit 260 may be connected in parallel to receive pressurized fluid from only the first pump 251 for dependent movement. The dependent movement of the right and left travel motors may function to provide substantially equal rotational speeds of the crawler tracks 108 (referring to FIG. 1), thereby propelling the machine 100 in a straight direction.

When the valve element 207 of the straight travel valve 299 is moved to the straight travel position, fluid from the first pump 251 may be substantially simultaneously directed via the valve element 207 through both the first hydraulic circuit 250 and the second hydraulic circuit 252 to drive the right and left travel motors. The second pressurized fluid from the second pump 253 may be directed to the actuators both the first hydraulic circuit 250 and the second hydraulic circuit 252 because the first pressurized fluid from the first pump 251 may be nearly consumed by the left and right travel motors during straight travel of the machine 100. It should be appreciated that the hydraulic system 200 may alternatively be arranged in a complimentary manner, with respect to the straight travel valve 299, such that when the valve element 207 is in the straight travel position, the right travel control circuit 258 and the left travel control circuit 260 may be connected in parallel to receive pressurized fluid from only the second pump 253, while fluid from the first pump 251 may be substantially simultaneously directed via valve element 207 through both the first hydraulic circuit 250 and the second hydraulic circuit 252 to their respective actuators.

A combiner valve 208 may selectively combine the first and second pressurized fluids from the first common supply passageway 266 and the second common supply passageway 270 for high speed movement of one or more fluid actuators. In particular, the combiner valve 208 may include a valve element 210 movable between a unidirectional open or flow-passing position (upper position shown in FIG. 2), a closed or flow-blocking position (middle position), and a bidirectional open or flow-passing position (lower position). When in the unidirectional open position, fluid from the first hydraulic circuit 250 may be allowed to flow into the second hydraulic circuit 252 (e.g., through a check valve 294) in response to the pressure of first hydraulic circuit 250 being greater than the pressure within second hydraulic circuit 252 by a predetermined amount. In this manner, when a stick and/or swing function requests a rate of fluid flow greater than an output capacity of the second pump 253, and the pressure within the second hydraulic circuit 252 begins to drop below the pressure within the first hydraulic circuit 250, fluid from the first pump 251 may be diverted to the second hydraulic circuit 252 by way of the valve element 210. Although shown downstream of the combiner valve 208, it should be appreciated that the check valve 294 may alternatively be included upstream of the combiner valve 208 or within the combiner valve 208, as desired. When in the closed position, substantially all flow through the combiner valve 208 may be blocked. When in the bidirectional open position, however, the first pressurized fluid may be allowed to flow to the second hydraulic circuit 252 to combine with the second pressurized fluid directed to the control circuits 262, and 263, and the second pressurized fluid may be allowed to flow to first hydraulic circuit 250 to combine with the first pressurized fluid directed to control circuits 254, 256, depending on a pressure differential across combiner valve 208.

Combiner valve 208 may be modulated to any position between the unidirectional open, closed, and bidirectional open positions. In this manner, a degree of the flow of pressurized fluid may be controlled based on, for example, the commanded velocities of the control circuits 254, 256, 262, 263, the commanded flow rates of the first pump 251 and the second pump 253, and/or the pressure differential across the combiner valve 208. For example, the valve element 210 may be a solenoid movable to any position between the flow-passing positions and the flow-blocking position in response to a current command.

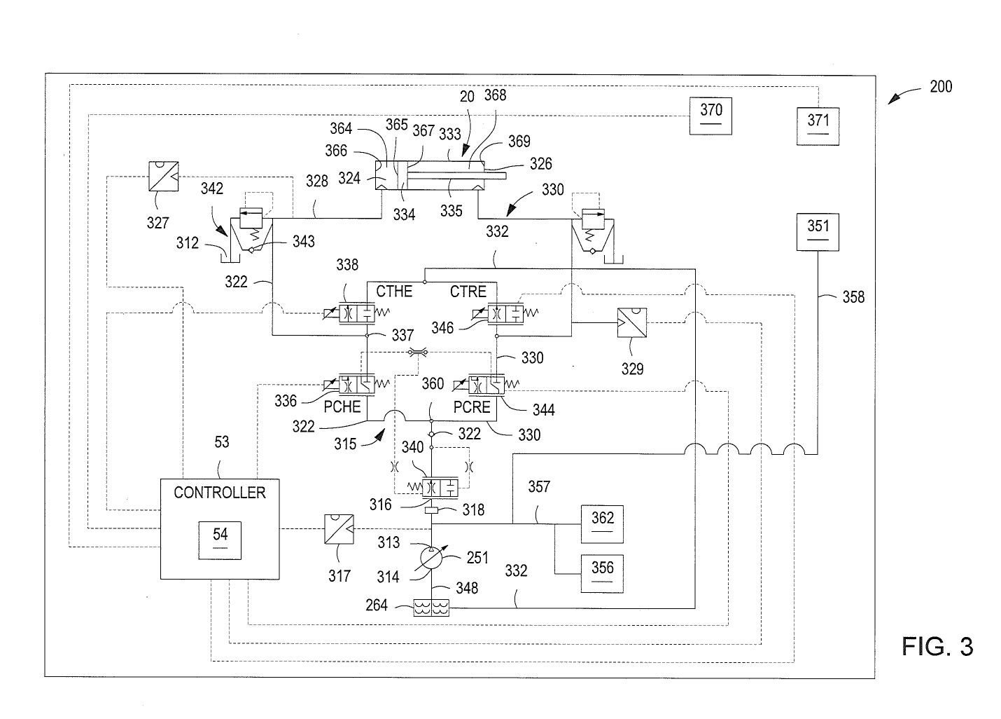

The hydraulic system 200 may also include a controller 53 in communication with an operator interface device and/or pump actuator pressure interface device (not shown), first pump 251 and/or second pump 253, combiner valve 208, the supply and drain elements of the control circuits 254, 256, 258, 260, 261, 262, 263. It is contemplated that the controller 53 may also be in communication with other components of hydraulic system 200 such as, for example, first and second bypass elements 295, 296, straight travel valve 299, and other such components of hydraulic system 200. The controller 53 may embody a single microprocessor or multiple microprocessors that include a means for controlling an operation of hydraulic system 200. Numerous commercially available microprocessors can be configured to perform the functions of the controller 53. It should be appreciated that the controller 53 could readily be embodied in a general machine microprocessor capable of controlling numerous machine functions. The controller 53 may include a memory 54 (as shown in FIG. 3), a secondary storage device, a processor, and any other components for running an application. Various other circuits may be associated with controller 53 such as power supply circuitry, signal conditioning circuitry, solenoid driver circuitry, and other types of circuitry.

The memory 54 may be storing one or more maps and/or a plurality of values representing power curves relating the interface device position signal, desired actuator velocity, associated flow rates, measured pressures or pressure differentials, and/or valve element position, for the actuators 20, 126, 130 (including any attachment actuators), left and right travel motors, and/or the swing motor. Each of these maps may include a collection of data in the form of tables, graphs, and/or equations. In one example, desired velocity and commanded flow rate may form the coordinate axis of a 2-D table for control of the first and second chamber supply elements. The commanded flow rate required to move the fluid actuators at the desired velocity and the corresponding valve element position of the appropriate supply element may be related in another separate 2-D map or together with desired velocity in a single 3-D map. It is also contemplated that desired actuator velocity may be directly related to the valve element position in a single 2-D map. The controller 53 may be configured to allow the operator to directly modify these maps and/or to select specific maps from available relationship maps stored in the memory 54 to affect fluid actuator motion. It is contemplated that the maps may additionally or alternatively be automatically selectable based on modes of machine operation.

The controller 53 may be configured to receive input from the operator interface device and/or pump actuator pressure interface device (not shown) to command operation of control circuits 254, 256, 258, 260, 261, 262, 263 in response to the input and the relationship maps described above. Specifically, the controller 53 may receive an interface device position signal indicative of a desired velocity and reference the selected and/or modified relationship maps the memory 54 of controller 53 may store to determine flow rate values and/or associated positions for each of the supply and drain elements within control circuits 254, 256, 258, 260, 261, 262, 263. The flow rates or positions may then be commanded of the appropriate supply and drain elements to cause filling of the first or second chambers at rates that result in the desired velocity.

The controller 53 may be configured to affect operation of combiner valve 208 in response to, for example, the commanded velocities of control circuits 254, 256, 258, 260, 261, 262, 263, the commanded flow rates of the first pump 251 and the second pump 253, and/or the pressure differential across the combiner valve 208. That is, if the determined flow rates associated with the desired velocities of particular fluid actuators meet predetermined criteria, the controller 53 may cause valve element 210 to move toward the unidirectional flow-passing position to supply additional pressurized fluid to the second hydraulic circuit 252, cause valve element 210 to move toward the bidirectional flow-passing position to supply additional pressurized fluid to the first hydraulic circuit 250 and/or the second hydraulic circuit 252, or inhibit the valve element 210 from moving out of the closed position.

The controller 53 may further be configured to control operation of the first pump 251 and/or the second pump 253 in conjunction with operation of the main relief valves 297, 298 to help avoid and/or reduce the magnitude of pressure spikes within the hydraulic system 200. In particular, based on demand generated by interface device and actual system pressures, as generated by one or more pressure sensors (e.g., one or more sensors associated with the common supply passageways 266, 270 and/or other areas of the system), the controller 53 may be configured to selectively increase or decrease the displacement and/or output power of the first pump 251 and/or the second pump 253. For example, the controller 53, in response to a request for an operation, may cause the hydraulic system 200 to operate at maximum power in which case the output power of the first pump 251 and the output power of the second pump 253 would be equal (e.g. one half of the maximum power). In another example, the controller 53 in response to a request for an operation may cause the hydraulic system 200 to operate at less than maximum power in which case the controller 53 would set the output power of the first pump 251 and the output power of the second pump 253 commensurate with the hydraulic power demand of the operation.

Referring to FIG. 3, a partial and more detailed schematic illustration of the hydraulic system 200 of FIG. 2 is provided for illustrative purposes to describe exemplary operation of hydraulic system 200 as it transitions in and out of an energy conservation mode. The description of FIG. 3 illustrates operation and interaction of one of the boom actuators 20. Therefore, FIG. 3 includes certain elements in common with FIG. 1 and FIG. 2. For instance, FIG. 3 depicts one instance of the boom actuators 20, the controller 53 (FIG. 2), the first pump 251, and the tank 264. Additionally, certain elements of FIG. 3 that do not need to be shown in detail to inform the accompanying description of the operation of machine 100 in energy conservation mode are, for ease of illustration, grouped together into functional blocks. For instance, a bucket circuit 351 may include bucket actuator 130, bucket control circuit 254 and associated circuitry and may be fluidly coupled to the bucket 52. A stick circuit 362 may include arm actuator 126, stick control circuit 262 and associated circuitry and may be fluidly coupled to the stick 55. A circuit 356 may represent other portions of the hydraulic system 200, such as the right travel control circuit 258 and associated actuators and circuitry, the left travel control circuit 260 and associated actuators and, the swing control circuit 261 and associated actuators and circuitry, and the attachment control circuit 263 and associated actuators and circuitry. An interface 370 in one example represents the device that is employed by an operator to control the boom 50 and/or the bucket 52. An interface 371 in one example represents the device that is employed by the operator to control other aspects of the machine 100, such as the stick 55, an attachment, and/or the drive motors. It should be appreciated that the preceding interfaces are provided for illustration and may be combined or divided. Examples of such interfaces include, but are not limited to devices such as joysticks, nobs, levers, keyboards, touch screens, pointing devices, etc.

Referring further to FIG. 3, the boom actuator 20 in one example includes a head end 324 that is in fluid communication with the first pump 251 via the fluid line 315. The fluid line 315 may extend from the first pump 251 to the head end 324. Fluid line 315 may include a pump outlet line 316, an intermediate line 322 and an actuator head inlet line 328. The pump outlet line 316 may extend from the first pump 251 to a compensation valve 340. The intermediate line 322 may extend from the compensation valve 340 to a make-up circuit 342. The make-up circuit 342 may include a make-up valve 343 and may receive return fluid from other systems in the machine to tank 264 and under certain conditions provide such fluid to the head end 324 of the actuator 320 via the actuator head inlet line 328. The actuator head inlet line 328 may extend from the make-up circuit 342 to the head end 324 of the actuator 320. An actuator rod end line 330 may extend from the rod end 326 of the actuator 320 to the intermediate line 322. A tank line 332 may extend from valve 346 to the tank 264. Pressure sensors 327, 329 may be used to measure the pressures in the fluid line 315 proximal to the head end 324, and in the actuator rod end line 330, respectively. A back pressure check valve 318 may be disposed in the pump outlet line 316 and a pressure sensor 317 may be used to measure the pressure at the outlet 313 of the first pump 251.

The boom actuator 20 may include a body 333, which is generally cylindrical and accommodates a piston 334 that separates the head end 324 from the rod end 326 of the boom actuator 20. The piston 334 may also be connected to the rod 335 which, in turn, may be coupled to the piece of equipment being moved which may, for example, be the boom 50 of the machine 100. The piston 334 may be moveable between an extended position and a retracted position, as is known in the art. The boom actuator 20 includes an internal head end compartment 364 and an internal rod end compartment 368. The internal head end compartment 364 is bounded by the head end wall 366 and the face 365 of the piston 334. The internal rod end compartment 368 is bounded by the back 367 of the piston 334 and the rod end wall 369. The back 367 is generally considered to be circumferentially encircling the rod 335. The surface area A_{H} of the face 365 is typically larger than the surface area A_{R} of the back 367 because of the area covered by the connection of the rod 335 to the back 367.

As noted above, the boom 50 may be coupled to a work implement, such as the bucket 52. FIG. 3 further illustrates communication between the first pump 251 and the stick circuit 362 and the circuit 356 via line 357 and communication between the first pump 251 and the bucket circuit 351 via the bucket line 358. Further, FIG. 3 also illustrates communication between the pressure sensors 317, 327, 329, the valves 336, 338, 344, 346 and the first pump 251 with the controller 53.

Referring further to FIG. 3, during an operational mode in which the energy conservation mode is inactive, the first pump 251 may draw fluid from the tank 264 for flow to the head end 324 of the boom actuator 20 to move the rod 335 and thus the boom 50 in an upward position. When pumping fluid from the tank 264 to the head end 324 of the boom actuator 20, pressurized fluid from the first pump 251 flows past the back pressure check valve 318 in pump outlet line 316, through the compensation valve 340, and through a pump-cylinder-head-end (PCHE) valve 336. Usually, when supplying fluid into the head end 324 of the boom actuator 20, the PCHE valve 336 is an open position, and a cylinder-tank-head-end (CTHE) valve 338 is a closed position. With the CTHE valve 338 in a closed position, fluid may flow through the PCHE valve 336, through the intermediate line 322, past junction 337, and through the actuator head inlet line 328 into the head end 324 of the boom actuator 20. Fluid may leave the rod end 326 of the boom actuator 20 via the actuator rod end line 330. A pump-cylinder-rod-end (PCRE) valve 344 is in a closed position and a cylinder-tank-rod-end (CTRE) valve 346 is an open position. The pressurized fluid flows from the rod end 326 of the boom actuator 20 through the actuator rod end line 330, through the CTRE valve 346, and through the tank line 332 to the tank 264.

Generally, during a digging phase, the boom 50 is typically held in place and there is a low first pump demand, while the first pump 251 demand is driven by the bucket 52. During the digging phase, the pressure in the rod end 326 of the boom actuator 20 is substantially higher than in the head end 324. Since the boom 50 is down, the PCHE valve 336 is in a marginally open position or a closed position based on an interface command and thus the flow delivered to the boom actuator 20 is minimal. Fluid from the first pump 251 (at a substantially high pressure) is delivered to the bucket circuit 351 based on an interface command to support the digging operation.

At some point, the machine 100 may transition to the digging-boom-up-overrunning-load phase. During this phase, the bucket 52 is actively digging but the boom 50 is being raised a relatively small distance from a lower position to a higher position. Typically, this small upward movement may be utilized to improve the digging load condition. In this situation, the reaction force F₀ on the boom 50 (induced by the bucket 52 through the stick 55) from the digging contact with the ground is greater than the resistive force of gravity Fₐ, which acts in opposition to the small upward movement of the boom 50, resulting in a net force F_{N} in the general direction of the reaction force F₀. In this scenario, the force on the boom actuator 20 at the rod end 326 (the “rod end actuator force”) is greater than the force on the boom actuator 20 at the head end 324 (the “head end actuator force”). The head end actuator force may be defined as equivalent to the surface area of the face of the piston 334 A_{H} times the pressure of the fluid at the head end 324. The rod end 326 actuator force may be defined as equivalent to the surface area of the back of the piston 334 A_{R} times the pressure of the fluid at the rod end 326. Given that the surface area of the face 365 A_{H} is greater than that of the back 367 A_{R}, it follows that, in this scenario, the fluid pressure in the fluid line 315 proximal to the head end 324 is less than the fluid pressure in the actuator rod end line 330 proximal to the rod end 326. (While there may be a relatively high fluid pressure at the rod end 326 of the boom actuator 20, there may often be almost zero fluid pressure at the head end 324.) The net force F_{N} moves the boom 50 upward in the general direction of the reaction force F₀ (induced by the bucket 52 interaction with the ground). The above factors result in a load condition that is regarded as an overrunning load condition. During such, the first pump 251 can provide a flow of highly pressurized fluid to the bucket 52 to continue digging and provide a flow of highly pressurized fluid to the head end 324 of the boom actuator 20 to avoid actuator voiding when the head end is at a substantially lower pressure.

In hydraulic systems, the compensation valve 340 may, as is known in the art, be utilized to reduce the pressurization level of fluid flowing to the head end 324 from the pressure level that is provided to the bucket circuit 351 during an overrunning load condition. This modulation, or reduction, of the pressure of the fluid provided to the head end 324 results in energy losses and lower energy efficiency for the hydraulic system. The compensation valve 340 may be a hydro-mechanically actuated proportional control valve and may be configured to control a pressure of the fluid supplied to regeneration junction 360. In one embodiment, the compensation valve 340 may include a valve element that is spring biased and hydraulically biased toward a flow passing position and moveable by hydraulic pressure toward a flow blocking position. Alternatively, the compensation valve 340 may include a valve element that is spring biased and hydraulically biased toward a flow blocking position and moveable by hydraulic pressure toward a flow passing position. The energy conservation mode of the hydraulic system 200 when the boom actuator 20 is operating under an overrunning load condition will now be explained.

To minimize energy loss due to pressure modulation by the compensation valve 340, the memory 54 within controller 53 may include software that can detect the overrunning load condition (digging-boom-up-overrunning-load phase), and implement, for the hydraulic system 200, an energy conservation mode configuration. In the energy conservation mode configuration, the controller may command the CTRE valve 346 to the fully closed position or substantially closed position to reduce flow from the rod end 326 to the tank 264, and the PCRE valve 344, along with PCHE valve 336 to an open, or at least partially open, position to redirect flow from the rod end 326 to the head end 324. The controller 53 commands the PCHE valve 336 to move to a partially open position (partially closed position) to allow less flow than that needed by the head end 324 to perform the function requested by the operator, and the CTHE valve 338 to move to the closed position.

Pressurized fluid leaves the rod end 326 of the boom actuator 20 via the actuator rod end line 330. Since the CTRE valve 346 is in either a fully closed position or substantially closed position, the pressurized fluid from the rod end 326 flows through the actuator rod end line 330 to the open PCRE valve 344, passes through the PCRE valve 344 and flows to fluid line 315 at regeneration junction 360. The fluid from the rod end 326 that flows into regeneration junction 360 may be referred to herein as “regenerated fluid.” In one embodiment, such regenerated fluid may be combined with the fluid from the first pump 251 (the “combined fluid”) at regeneration junction 360. The combined fluid may flow to the PCHE valve 336, which has been placed in a partially open (partially closed) position as explained above. Such combined fluid flows from the PCHE valve 336, through the intermediate line 322, and through the actuator head inlet line 328 to the head end 324 of the boom actuator 20. Because the PCHE valve 336 opening is partially reduced, the flow of combined fluid through the PCHE valve 336 is also partially reduced and results in a reduced flow of combined fluid to the head end 324 of the boom actuator 20. Make-up flow from the make-up circuit 342 may also be used to supplement the combined fluid flow to the head end 324. As used herein, the fluid from the make-up circuit 342 may be referred to as “make-up fluid.” In another embodiment, the fluid received by the head end 324 of the actuator may be combined fluid substantially without or without make-up fluid. In yet another embodiment, the fluid received by the head end 324 of the actuator may be regenerated fluid and make-up fluid substantially without or without fluid from the first pump 251.

The preceding configuration during an overrunning load condition, minimizes energy loss at the compensation valve 340 because such a configuration allows a smaller volume of fluid to be provided by the first pump 251 than would otherwise be provided in the absence of supplementing the amount of the fluid provided to the head end 324 with regenerated fluid and/or make-up fluid. Power loss due to modulation by the compensation valve 340 of the fluid provided by the first pump 251 may be calculated by the following equation:

Power Loss=Q×ΔP Eq. 1.

where Q is the flow rate of the fluid and ΔP is the pressure difference between the fluid at the outlet 313 of the first pump 251 and the fluid (post compensation valve 340) provided by the first pump 251 to the head end 324 of the boom actuator 20. Since the utilization of an amount of regenerated fluid and make-up fluid allows less fluid flow to be provided by the first pump 251, there is less power lost when the compensation valve 340 drops the relatively high pressure of the pumped fluid (from the first pump 251) to a lower pressure appropriate for the boom 50 operation. The configuration of FIG. 2 also provides an anti-voiding strategy for the head end of the actuator during the overrunning load condition.

At some point, in the digging cycle, the machine 100 may transition to the digging-boom-up-light-resistive-load phase. During this phase, the bucket 52 is digging and the boom 50 is being raised from a lower position to a higher position. What sets this apart from the digging-boom-up-overrunning-load phase is that in the digging-boom-up-light-resistive-load phase, the reaction force Fᵤ on the boom 50 (induced by the bucket 52 and stick 55) from digging is less than the resistive force of gravity Fₐ that acts in opposition to the upward movement of the boom 50. The head end 324 actuator force is somewhat greater than the rod end 326 actuator force. The fluid pressure in the fluid line 315 proximal to the head end 324 is generally smaller than the fluid pressure in the actuator rod end line 330 proximal to the rod end 326, due to the difference in the surface area of the face 365 A_{H} being greater than that of the back 367 A_{R} (i.e. A_{H}>A_{R}). This is known as a light-resistive load condition. The first pump 251 provides a flow of highly pressurized fluid to the bucket 52 to continue digging and also provides a flow of pressurized fluid to the head end 324 of the boom actuator 20. The energy conservation mode of the hydraulic system 200 when the boom actuator 20 is operating under a light-resistive load condition will now be explained. To minimize energy loss due to pressure modulation by the compensation valve 340, the memory 54 may include software that can detect the light-resistive load condition, and implement, for the hydraulic system 200, the following configuration:

In the configuration, the CTRE valve 346 is either fully closed, or substantially closed to reduce rod end 326 flow to the tank 264, the PCRE valve 344 is open, or partially open, to redirect rod end 326 flow to the head end 324. The PCHE valve 336 is open, or partially open, to meet the flow demand required by the boom 50 operation. Pressurized fluid leaves the rod end 326 of the boom actuator 20 via the actuator rod end line 330. Since the CTRE valve 346 is either fully closed or substantially closed, the pressurized fluid from the rod end 326 flows through the actuator rod end line 330 to the PCRE valve 344, passes through the open PCRE valve 344 and flows to fluid line 315 at regeneration junction 360. Such pressurized regenerated fluid is combined with the pressurized fluid from the first pump 251 (combined fluid) at regeneration junction 360. The combined fluid flows through the open PCHE valve 336. The combined fluid flows from the PCHE valve 336, through the intermediate line 322, and through the actuator head inlet line 328 to the head end 324 of the boom actuator 20. Make-up fluid does not enter the head end 324 of the boom actuator 20 because the head end 324 pressure is higher than the pressure of the make-up fluid. Because the combined fluid through the PCHE valve 336 is not supplemented by the make-up fluid, the first pump 251 may provide a greater flow rate as compared to (the flow rate provided itself) when the load condition was in an overrunning load condition.

The preceding configuration of the hydraulic system 200, during a digging-boom-up-light-resistive-load phase (light-resistive load condition), minimizes energy loss at the compensation valve 340 because it allows a smaller volume of fluid to be provided by the first pump 251 than would otherwise be provided in the absence of supplementing the fluid provided to the head end 324 with regenerated fluid. Since the utilization of pressurized regenerated fluid allows less fluid flow to be provided by the first pump 251, there is less power lost when the compensation valve 340 drops the relatively high pressure of the pumped fluid to a lower pressure appropriate for the boom 50 operation.

At some point, in the digging cycle, the machine may transition to the boom-lift phase (heavy-resistive load condition). During this phase, the bucket 52 is not digging and the boom 50 is being moved. In this boom-lift phase, the first pump 251 provides a flow of pressurized fluid to the head end 324 of the actuator. In the exemplary embodiment, since there is no digging, the pressure of the fluid provided by the first pump 251 may be substantially controlled by the requirements of the boom actuator 20, thus, typically there may be no substantial power lost through use of the compensation valve 340. The head end 324 actuator force, when there is a heavy load, is greater than the rod end 326 actuator force by at least a predetermined value. The pressure in the fluid line 315 proximal to the head end 324 of the boom actuator 20 is greater than the fluid pressure in the actuator rod end line 330 proximal to the rod end 326. The fluid pressure in the fluid line 315 proximal to the head end 324 may be about the same as the fluid pressure in the pump outlet line 316. For example, the fluid pressure in the fluid line 315 proximal to the head end 324 may be in a range from about equal to the fluid pressure in the pump outlet line 316 to about ninety (90) percent of the fluid pressure in the pump outlet line 316. In another embodiment, the fluid pressure in the fluid line 315 proximal to the head end 324 may be in a range from about equal to the fluid pressure in the pump outlet line 316 to about ninety-five (95) percent of the fluid pressure in the pump outlet line 316. In yet another embodiment, the fluid pressure in the fluid line 315 proximal to the head end 324 may be in a range from about equal to the fluid pressure in the pump outlet line 316 to about ninety-eight (98) percent of the fluid pressure in the pump outlet line 316. The above is known as a heavy-resistive load condition. The controller 53 may be equipped with a memory 54, including software, that can detect the transition to the heavy-resistive load condition and implement a configuration for the hydraulic system 200 in which the energy conservation mode is inactive.

### INDUSTRIAL APPLICABILITY

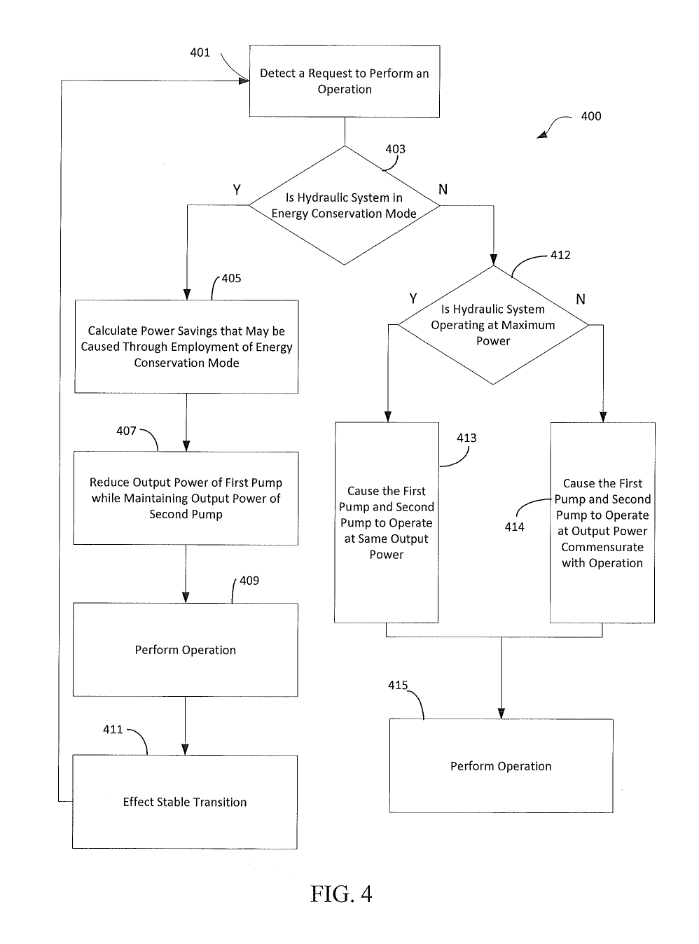

Referring now to FIG. 2 and FIG. 4, an exemplary method 400 of operating the hydraulic system 200 to perform of energy conservation through employment of independent pump control will now be described for illustrative purposes. In one embodiment, while using the machine 100 shown in FIG. 1, the operator may initiate an operation. In one example, the operator initiates the operation through interface 370 and/or interface 371. In one embodiment, the operator may initiate the operation during a time period in which the energy conservation mode is inactive. In another embodiment, the operator may initiate the operation during a time period in which the energy conservation mode is active. The operation in one example may be a digging operation that triggers an energy conservation mode configuration in hydraulic system 200. For instance, the operation may trigger the controller 53 to cause or initiate the digging-boom-up-overrunning-load phase described above in connection with FIG. 3. In another example, the operation may trigger the controller 53 to cause the digging-boom-up-light-resistive-load phase also described above in connection with FIG. 3.

Referring further to FIG. 2 and FIG. 4, in step 401, the controller 53 can detect the request to perform an operation. In one example, the operation may have a hydraulic power demand. For example, the hydraulic power demand may be an amount of power to actuate the hydraulic system 200 to perform the operation. The hydraulic power demand may vary depending on the operation and/or the performance desired by the operator, which may be reflected by the operator actuating an interface 370, 371 (FIG. 3). In one example, the request may include a command to lift the boom 50. In another example, the request may include a command to dig using the bucket 52. In a further example, the request may include a multi-part command that includes a command to lift the boom 50 and a command to dig using the bucket 52.

In step 403, the controller 53 can make a determination as to whether or not the hydraulic system 200 is in an energy conservation mode. For instance, the controller 53 makes the determination by executing software that detects by reading an entry in memory 54 that the hydraulic system 200 is in an energy conservation mode. In another example, controller 53 may determine to place the hydraulic system 200 in an energy conservation mode in response to a detected request in step 401 to that may trigger the digging-boom-up-overrunning-load phase or the digging-boom-up-light-resistive-load phase referred to herein when discussing FIG. 3. In such an example, the controller 53 may make the determination that hydraulic system 200 is in an energy conservation mode by the act of controller 53 entering the hydraulic system 200 into an energy conservation mode. In another example, the controller 53 may make a determination that the hydraulic system 200 is not energy conservation mode by controller 53 deactivating the energy conservation mode.

In step 405, if the controller 53 can determine that the hydraulic system 200 is in the energy conservation mode, the controller 53 calculates the power savings that may be caused by executing the operation in energy conservation mode. In one example, such a calculation may be performed by the controller 53 executing software in the memory 54. For instance, if the operator of machine were to request the boom 50 to lift a certain velocity while simultaneously exerting a certain force by digging with bucket 52, the software may translate the requested velocity and force to values that it may utilize to calculate the magnitude of power that may be conserved by performing such an operation in an energy conservation mode. In one example the software may calculate the magnitude of power that may be conserved by determining how much less fluid needs to be provided by the first pump 251 to the boom actuator 20 due to use of regenerated fluid as in FIG. 3. In another example, the controller 53 may access data tables in memory 54 that include power savings values due to the use of the employment of regenerated fluid for a given operation or set of operations.

In step 407, in one example, the controller 53 can cause the output power of the first pump 251 (first output power) to be set at a first value and causes the output power of the second pump 253 (second output power) to be a second value. For instance, the controller 53 may set the first output power to the first value and set the second output power to a second value that is greater than the first value. In another example, first output power and the second output power may be equal prior to the request for the operation, and the controller 53 may reduce the output power of the first pump 251 while causing the output power of the second pump 253 to remain at its current state (i.e. maintaining the output power of the second pump 253 at the value of output power prior to detection of a request to perform an operation in step 401).

In one example, the controller 53 may cause the output power of the first pump 251 to decrease by a value in proportion to the energy savings calculated in step 405. For instance, if the controller 53 calculated in step 405 that a certain amount of energy (X) may be saved by performing the operation in an energy conservation mode, then the controller 53 may reduce the output power of the first pump 251 by the value of X. In another example, the controller 53 may reduce the output power of the first pump 251 by a percentage of the value of X. In a further example, the controller 53 may access a power curve or a plurality of power curves that are pre-calculated and stored in memory 54. Each power curve may provide a plurality of values for how much the output power of the first pump 251 should be reduced for a given amount of energy savings resulting from energy conservation mode. In another example, such power curves may be used for calculating power savings that may result from performing the operation in the energy conservation mode. In another example, the controller 53 may calculate determine a hydraulic power demand to execute an operation, subtract the power savings from the hydraulic power demand and set the first pump 251 output power to the difference.

In step 409, controller 53 can cause machine 100 to execute the operation while the output power for the first pump 251 is reduced. In step 411, after execution of the operation, the controller 53 effects a stable transition away by gradually increasing the output power of the first pump 251 to return to the output power under which it was operating prior to reducing the output power in step 407.

Referring to step 403 of FIG. 4, it can be seen that if the hydraulic system 200 is not in energy conservation mode after receiving the request in step 401, then in step 412, the controller 53 determines whether or not they hydraulic system 200 is and/or should be operating at maximum power. For instance, the controller 53 makes the determination by executing software that detects by reading an entry in memory 54 that the hydraulic system 200 is operating at maximum power. In another example, controller 53 may determine to cause hydraulic system 200 to operate at maximum power in response to a detected request in step 401. In such an example, the controller 53 may make the determination that hydraulic system 200 is operating at maximum power by the act of controller 53 placing the hydraulic system 200 at maximum power in response to the request. If the controller 53 determines that the hydraulic system 200 is and/or should be at maximum power, then, in step 413, the controller 53 causes the first pump 251 and the second pump 253 to have the same output power, such as one half of maximum power. In one example, the controller 53 maintains the first pump 251 and the second pump 253 at the value of output power they had prior to commencement of the operation. If the controller 53 determines that the hydraulic system 200 is not and/or does not need to operate at maximum power, then in step 414, the controller 53 operates the hydraulic system 200 such that the first pump 251 and second pump 253 operate with respective output powers that are commensurate with the hydraulic power demand of the operation. In one example, these respective output powers are calculated by controller 53 by referring to one or more power curves stored in memory 54. In step 415, the machine 100 performs the operation.

A hydraulic system 200 and method 400 is disclosed for conserving energy by rod end 326 to head end 324 flow regeneration when an actuator, such as a boom actuator 20, has an overrunning load condition or a light-resistive load condition. To optimize energy conservation, independent pump control is utilized. In one example, the output power of a first pump 251 is reduced in proportion to energy savings achieved by flow regeneration while the output power of second pump 253 is maintained. Such a hydraulic system 200 and method 400 may be utilized to conserve energy in machines, such as a machine 100, a backhoe, a hydraulic shovel, or other types of machines utilizing hydraulics.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hydraulic system, comprising:
a first hydraulic circuit;
a second hydraulic circuit;
a first pump configured to provide a pressurized fluid to at least the first hydraulic circuit;
a second pump configured to provide the pressurized fluid to at least the second hydraulic circuit; and
a controller configured to:
determine whether or not the hydraulic system is operating in an energy conservation mode;
when the hydraulic system is not operating in the energy conservation mode, operate the first pump proportional to a hydraulic power demand of at least the first hydraulic circuit and the second pump proportional to a hydraulic power demand of at least the second hydraulic circuit; and
when the hydraulic system is operating in the energy conservation mode, operate at least the first pump at an output power less than the hydraulic power demand of at least the first hydraulic circuit.

2. The hydraulic system of claim 1, wherein the controller is configured to:
calculate a power savings for the first pump resulting from the hydraulic system operating in the energy conservation mode; and
reduce the output power proportional to the power savings.

3. The hydraulic system of claim 2, wherein the controller includes a memory and is configured to:
store a plurality of values representing a power curve for the first pump in the memory; and
utilize the power curve to calculate the power savings.

4. The hydraulic system of claim 1, wherein the controller is configured to:
operate the first pump at a first output power and the second pump at a second output power when the hydraulic system is at maximum power; wherein the first output power is equal to the second output power when the hydraulic system is not operating in energy conservation mode.

5. The hydraulic system of claim 4, wherein the first output power is less than the second output power when the hydraulic system is operating in the energy conservation mode.

6. They hydraulic system of claim 1, wherein the first hydraulic circuit comprises a hydraulic cylinder.

7. The hydraulic system of claim 6, wherein at least a portion of the pressurized fluid flows from a rod end of the hydraulic cylinder to a head end of the hydraulic cylinder when the first hydraulic circuit operates in the energy conservation mode.

8. The hydraulic system of claim 1, wherein the first hydraulic circuit is coupled to a boom that is coupled to a work implement.

9. A method of operating a hydraulic system, wherein the hydraulic system includes a first hydraulic circuit, a first pump that provides a pressurized fluid to the first hydraulic circuit, a second hydraulic circuit, a second pump that provides the pressurized fluid to the second hydraulic circuit, the method comprising:
determining that the first hydraulic circuit is operating in an energy conservation mode;
calculating a power savings that may be caused by operating the first hydraulic circuit in the energy conservation mode; and
reducing an output power of the first pump in proportion to the power savings.

10. The method of claim 9, further comprising:
operating the first pump and the second pump at an output power equal to a first value when the energy conservation mode is inactive.

11. The method of claim 10, further comprising:
operating the first pump at an output power less than the first value when the energy conservation mode is active.

12. The method of claim 11, further comprising:
operating the second pump at an output power equal to the first value when the first hydraulic circuit is operating in the energy conservation mode.

13. The method of claim 9, further comprising:
storing a plurality of values representing a power curve for the first pump;
utilizing the power curve to calculate the power savings.

14. The method of claim 9, further comprising:
utilizing the first hydraulic circuit to actuate a boom and a bucket coupled to a work implement.

15. The method of claim 14, further comprising:
receiving a bucket control command to use the bucket to dig;
receiving a boom control command to move the boom upward; and
entering the energy conservation mode in response to receiving the boom control command.

16. The method of claim 9, further comprising:
deactivating the energy conservation mode.

17. The method of claim 16, further comprising:
increasing the output power of the first pump in proportion to the power savings.

18. A machine including:
a boom;
a bucket connected to the boom;
a hydraulic circuit that is employed to actuate the boom and the bucket;
a pump for providing a pressurized fluid to the hydraulic circuit at an output power; and
a controller configured to:
receive a boom control command to move the boom upward and a bucket control command to dig;
reduce an amount of the pressurized fluid that is provided by the pump to the hydraulic circuit;
calculate a power savings that may be caused by reducing the amount of the pressurized fluid that is provided to the hydraulic circuit; and
reduce the output power of the pump in proportion to the power savings.

19. The machine of claim 18, wherein the hydraulic circuit comprises:
a hydraulic cylinder, wherein reducing the output power of the pump comprises:
transferring the pressurized fluid from a rod end to a head end of the hydraulic cylinder.

20. The machine of claim 19, wherein the controller is configured to:
determine a hydraulic power demand to execute the boom control command and the bucket control command;
calculate a difference between the hydraulic power demand and the power savings; and
operate the pump wherein the output power is equal the difference.
